(19) United States
(12) Patent Application Publication
(10) Pub. No.: US 2016/0225553 A1
(43) Pub. Date: Aug. 4, 2016

(54) DRIVER FOR AN ELECTRICAL SWITCH AND AN ELECTRICAL SWITCH INCLUDING SUCH A DRIVER

(71) Applicants: Legrand France, Limoges (FR); Legrand SNC, Limoges (FR)

(72) Inventor: Jean-Sebastien GUIBERT, NIEUL (FR)

(21) Appl. No.: 15/013,325

(22) Filed: Feb. 2, 2016

(30) Foreign Application Priority Data
Feb. 3, 2015 (FR) 1550839

(51) Int. Cl. H01H 13/20; H01H 13/14

(52) U.S. Cl. CPC H01H 13/20; H01H 13/14

(57) ABSTRACT

A driver (200) for an electrical switch (100), which driver is adapted to move between two positions so as to make or break contact between a movable contact element and a stationary contact element, and which driver includes a top portion (210) that includes a mount element with two outside faces (212B, 213B) that face away from each other, each provided with first catch elements (214) for mounting a first type of control button on the driver. The mount element includes second catch elements (215) that are accessible in an internal region (R) that is situated between the outside faces, for mounting a second type of control button on the driver.

### TECHNICAL FIELD TO WHICH THE INVENTION RELATES

The present invention generally relates to field of electrical switches.

It relates more particularly to a driver for an electrical switch, which driver is adapted to move between two positions so as to make or break contact between a movable contact element and a stationary contact element, and which driver includes a top portion that includes a mount element with two outside faces that face away from each other, each provided with first catch means for mounting a first type of control button on the driver.

It also relates to an electrical switch including such a driver.

### TECHNOLOGICAL BACKGROUND

Electrical switches as specified above and adapted to receive a type of control button that is particularly arranged to be mounted on the driver are currently known.

However, various types of control button exist that differ from one another by their various shapes: some control buttons are wide, others are narrower. Some present two actuation zones at their longitudinal ends, whereas others present a central actuation lever.

Each driver is adapted to receive a particular type of control button by means of first catch means that are situated on the driver and that are adapted to mount that type of control button.

It is thus necessary to manufacture different types of driver so as to associate them with different types of control button, and the multiplicity of different stocks leads to high manufacturing costs.

### OBJECT OF THE INVENTION

In order to remedy the above-mentioned drawback of the prior art, the present invention proposes a novel driver for an electrical switch that is adapted to co-operate with control buttons of different types.

More particularly, the invention proposes a driver as defined in the introduction, in which said mount element includes second catch means that are distinct from said first catch means and that are accessible in an internal region that is situated between said outside faces, for mounting a second type of control button on said driver.

Thus, by means of the invention, a single driver can receive various types of control button. Manufacture is thus simplified and costs are thus reduced, and use of the electrical switch is simplified, since it is no longer necessary to manufacture different types of driver, and it is no longer necessary to have the driver that is specially adapted to a particular type of control button.

The driver of the invention has other characteristics that are non-limiting and advantageous, as follows:

each first catch means includes a first catch surface that is adapted to co-operate, in retention, with complementary first catch means of said first type of control button;

each first catch surface forms part of a catch tooth or of a rib that projects from one of said outside faces of the mount element;

each first catch surface forms part of a housing or of a groove that is set back in one of said outside faces of the mount element;

four first catch means are provided, each arranged at a respective one of the ends of said outside faces of the mount element of said driver;

each first catch means is arranged in the proximity of the front edge of the outside face of the corresponding mount element;

said mount element includes two mount walls that are arranged facing each other, each of the mount walls including an inside face that faces the other mount wall and that faces away from one of said outside faces of the mount element, said inside faces of the mount walls co-operating with a main wall of the driver to define a portion of said internal region;

each second catch means includes a second catch surface that is adapted to co-operate, in retention, with complementary second catch means of said second type of control button;

each second catch surface forms part of a catch tooth or of a rib that projects from one of said inside faces of said mount walls, into the internal region;

each second catch surface forms part of a housing or of a groove that is set back in one of said inside faces of said mount walls, and that opens out into said internal region;

each of said housings or grooves opens out into an opening of the inside face of the corresponding mount wall, in the proximity of said main wall of the driver; and

second catch means are provided in each mount wall, which second catch means are arranged in the middle of the inside face of the mount wall.

The invention also proposes an electrical switch comprising a base housing an electrical switch mechanism with a movable electrical contact element, a stationary electrical contact element, and a driver, the driver being adapted to move between two positions so as to make or break contact between said movable contact element and said stationary contact element.

The electrical switch of the invention has other characteristics that are non-limiting and advantageous, as follows:

it further comprises a first type of control button having a width that makes it suitable for housing said mount element of the driver, and including a front wall from which two partitions extend, each provided with complementary first catch means that are adapted to co-operate, in retention, with said first catch means of the driver; and

it further comprises a second type of control button having a width that makes it suitable for being housed, at least in part, between the outside faces of the mount element of the driver, and including a front wall from which two drop walls extend, each provided with complementary second catch means that are adapted to co-operate, in retention, with said second catch means of the driver.

### DETAILED DESCRIPTION OF AN EMBODIMENT

The following description of non-limiting examples given with reference to the accompanying drawings makes it possible to understand what the invention consists of and how it can be reduced to practice.

In the accompanying drawings:

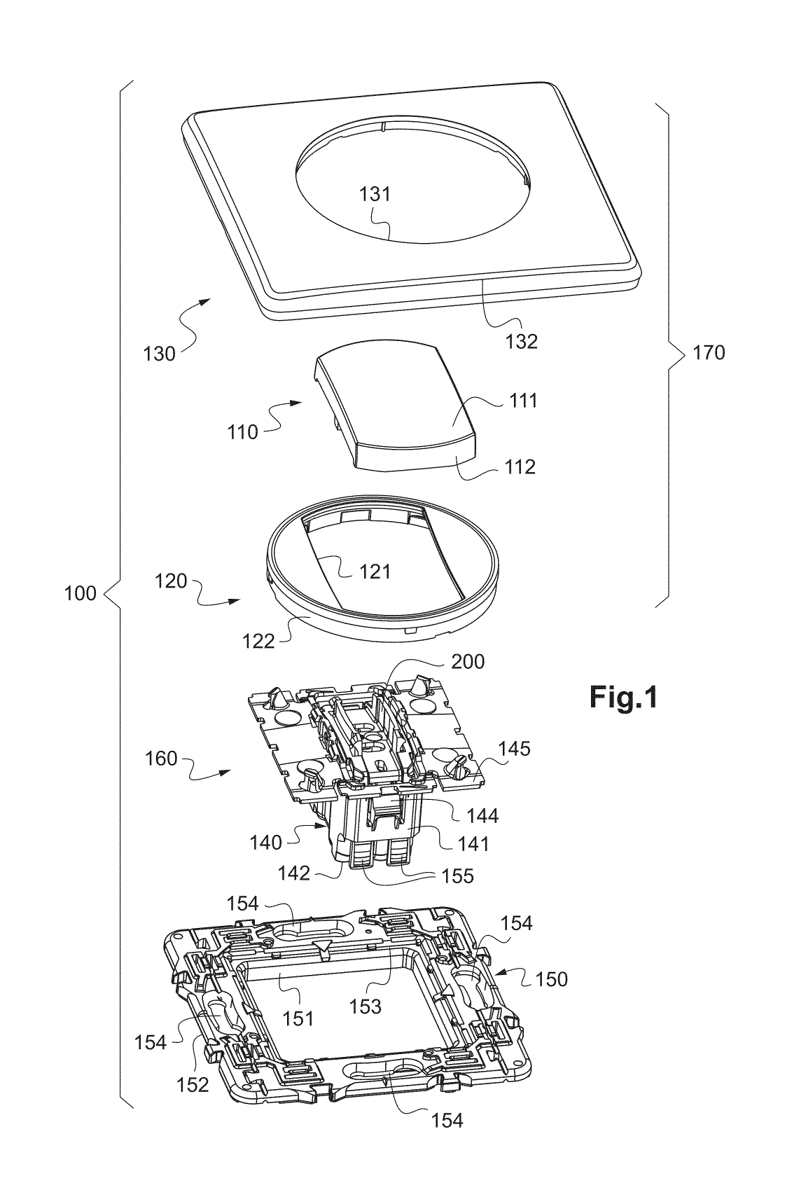

FIG. 1 is an exploded diagrammatic perspective view of an electrical switch of the invention with a first type of control button;

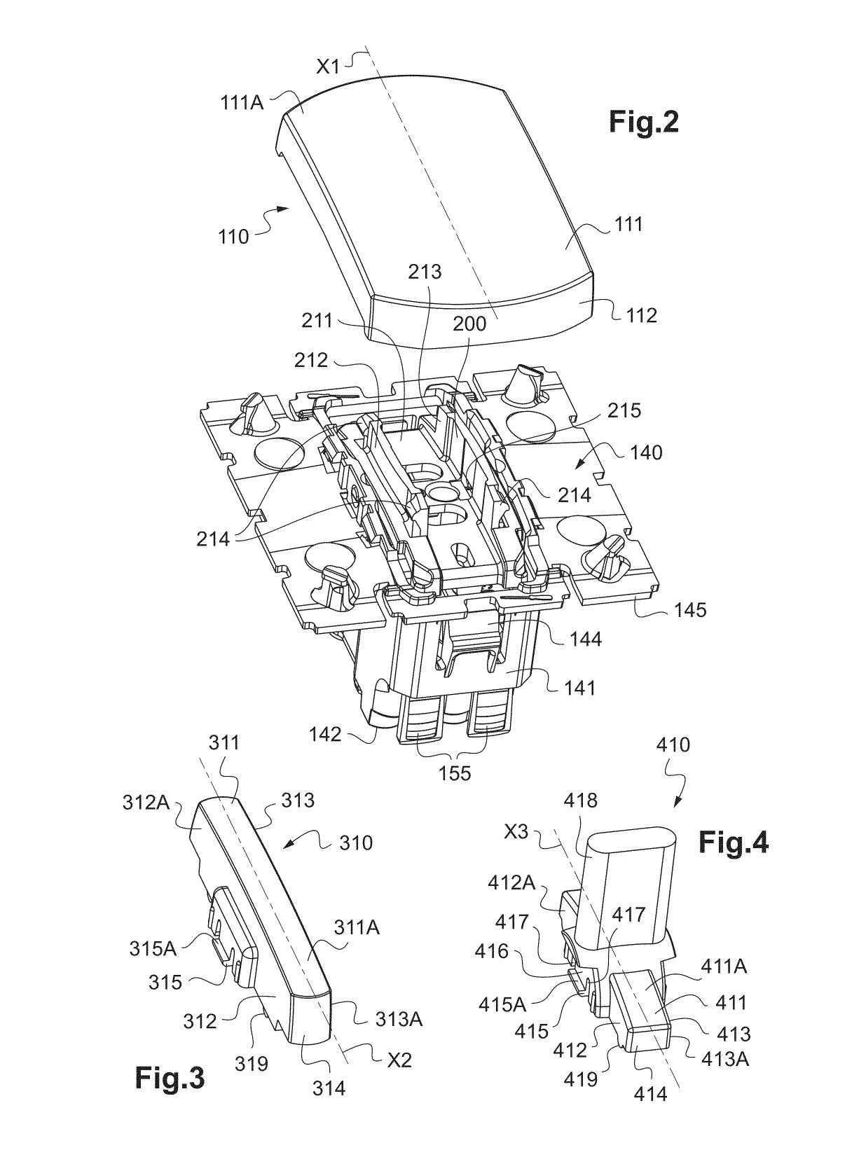

FIG. 2 is a partially-exploded diagrammatic view of the FIG. 1 electrical switch;

FIGS. 3 and 4 are diagrammatic perspective views of two embodiments of a second type of control button adapted to catch on the driver of the FIG. 1 electrical switch;

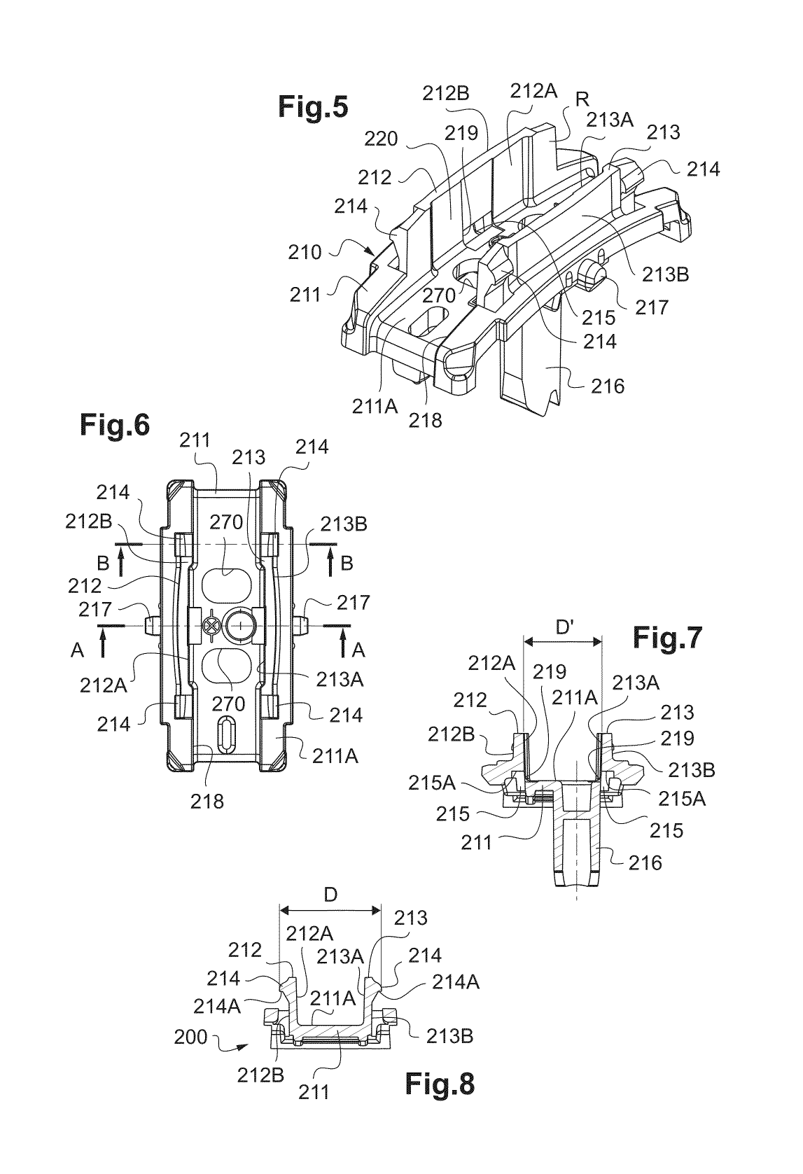

FIG. 5 is a diagrammatic perspective view of the driver of the FIG. 1 electrical switch;

FIG. 6 is a diagrammatic plan view of the FIG. 5 driver;

FIG. 7 is a diagrammatic section view on plane A-A of the FIG. 5 driver;

FIG. 8 is a diagrammatic section view on plane B-B of the FIG. 5 driver;

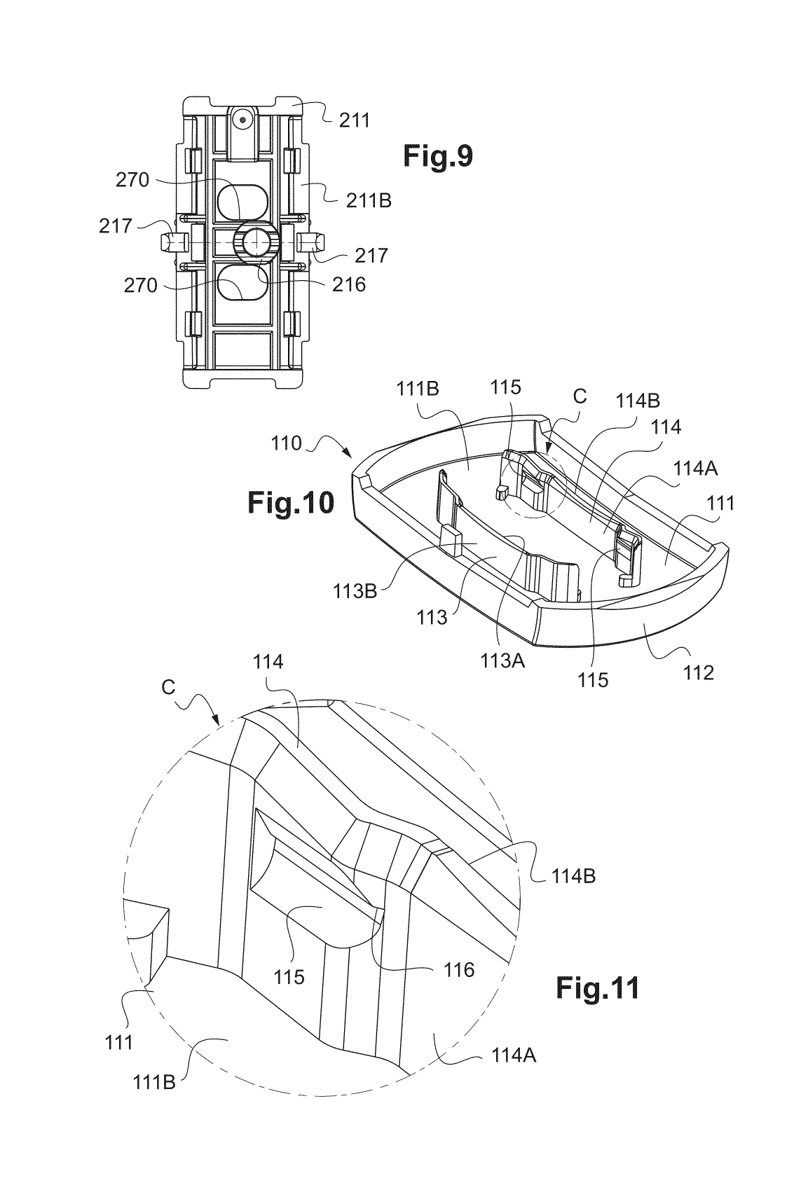

FIG. 9 is a diagrammatic view from below of the

FIG. 5 driver;

FIG. 10 is a diagrammatic perspective view of the first type of control button shown in FIGS. 1 and 2;

FIG. 11 is a diagrammatic larger-scale view of a detail C of FIG. 10;

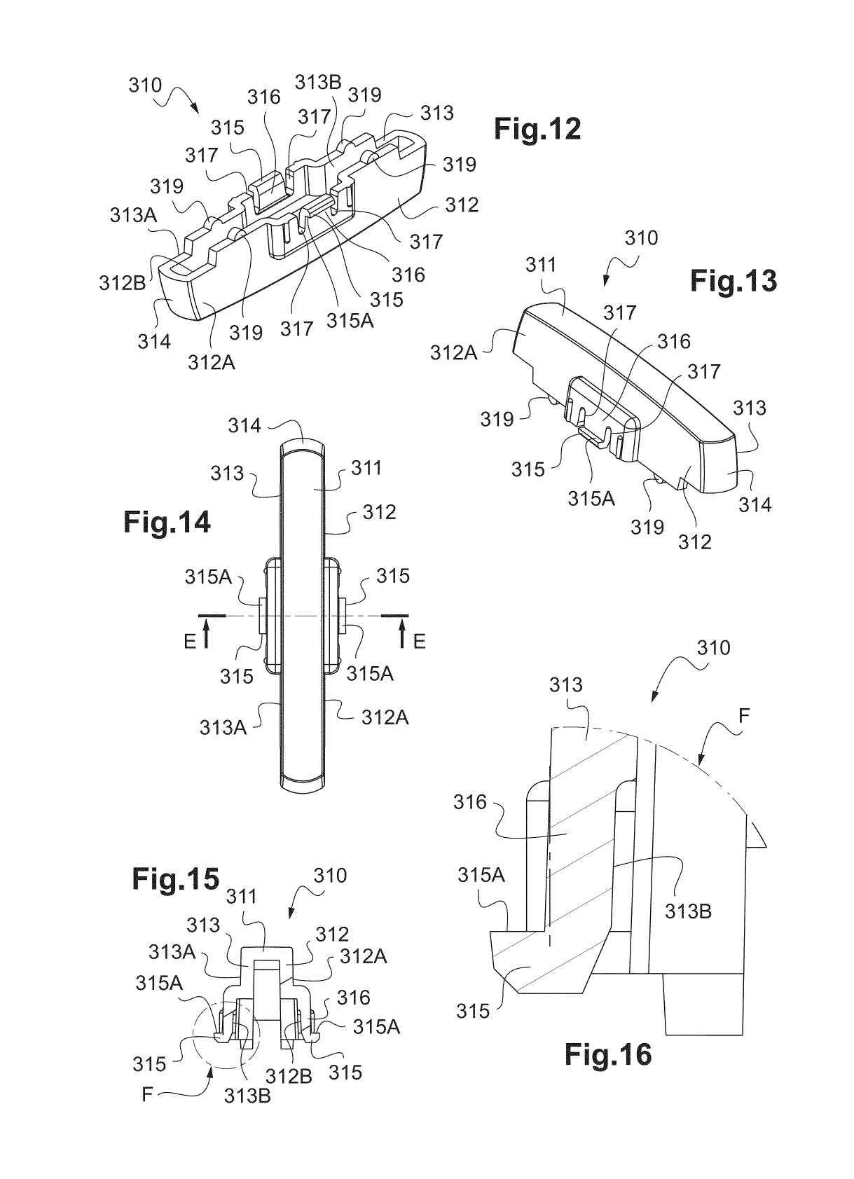

FIG. 12 is a diagrammatic rear view in perspective of the second type of control button shown in FIG. 3;

FIG. 13 is a diagrammatic front view in perspective of the second type of control button shown in FIG. 12;

FIG. 14 is a diagrammatic plan view of the second type of control button shown in FIG. 12;

FIG. 15 is a diagrammatic section view of the second type of control button on section plane E-E of FIG. 14; and

FIG. 16 is a diagrammatic larger-scale view of a detail F of FIG. 15.

FIG. 1 shows an electrical switch 100 of the invention.

The electrical switch of the invention may be of any type, externally actuated by a control button 110; 310; 410.

The control button may be a one-way switch or a two-way switch, or a control switch for controlling any electrical appliance.

Each control button 110; 310; 410 comprises a front portion that is accessible to the user and that faces towards the user, and a control portion that faces towards the switch mechanism and that is adapted to co-operate with a driver 200 for controlling said switch mechanism, as explained in greater detail below.

This control button 110; 310; 410 is rockable so as to actuate the electrical switch mechanism (not shown in the figures) that is housed in the electrical switch 100.

More precisely, the control button 110; 310; 410 is rockable about a rocking axis that is to extend parallel to the front face of a wall surface in which, or on which, said electrical switch is to be mounted.

However, it is possible to envisage that the control button is movable in translation: it could thus be an electrical switch of the push switch type.

The control button is thus movable in translation along a translation axis that is to extend perpendicularly to the front face of the wall surface in which, or on which, said electrical switch is to be mounted.

The electrical switch 100 is for housing in a box (not shown) for fitting on, or in, said wall surface, either by surface mounting the box on the wall or by flush mounting it in the wall.

It is then connected to the electricity network in order to power it.

In the description, the terms “front” and “rear” are thus used relative to the direction in which the user looks at the wall surface on which the electrical switch 100 is fitted. Thus, when the electrical switch is installed in a room, “front” means the face facing into the room, and “rear” means the face facing the opposite way, away from the room.

The electrical switch 100 comprises a switch assembly 160 comprising the electrical switch mechanism that is housed in an insulating base 140, and a front-face assembly 170 that closes the front of said switch assembly 160.

The base 140 presents the shape of a rectangular parallelepiped, and comprises a side wall 141 that is closed at the rear by a rear wall 142 (FIGS. 1 and 2). The base 140 is open at the front, and in its rear wall, internally houses its connection means for connecting to the local electricity network.

The electrical switch 100 further comprises an accessory-mechanism support 150, referred to below as a “support”, for mounting the base 140 inside the box (FIG. 1).

To this end, the support 150 is in the form of a flat frame of shape that is square, defined by an inner peripheral edge 151 and an outer peripheral edge 152 (FIG. 1). The inner peripheral edge 151 defines a central opening that is also square. The support 150 is thus formed of four branches corresponding to the four sides of the square frame.

The support 150 includes blocking means for fastening the base 140 of the accessory mechanism in its central opening, and securing means for fastening it to the reception box.

In the example shown in FIG. 1, the blocking means comprise firstly an inner collar 153 against which there bears a rim 145 of the base 140 that is engaged in the central opening of the support, and secondly a rib that forms the inner peripheral edge 151, and on which snap-fastener means 144 provided on the base 140 are adapted to catch so as to block the base 140 of the accessory mechanism rigidly inside the central opening of the support 150 (FIGS. 1 and 2).

In the embodiment shown, on two opposite sides of the side wall 141 of the base 140, the snap-fastener means 144 comprise a tab that is cut out in the side wall 141, and that is provided at its free end with a catch tooth.

In a variant, the support and the base may be formed as a single part, e.g. by molding a plastics material.

At the center of each of the four branches of the frame forming the support 150, the securing means for securing the support 150 include an orifice 154 in the shape of a key hole.

Two fastener screws are for engaging through two of the keyhole-shaped orifices 154 situated on two opposite branches of the support 150, so as to fasten the support 150 on its corresponding box (not shown).

In conventional manner, the connection means housed in the base 140 comprise two, three, or four electrical-connection terminals for connecting to the local electricity network, depending on the mode of operation of the electrical switch.

In conventional manner, the electrical-connection terminals may be automatic-connection terminals, such that each of them is operable by a disconnection lever that passes through an opening formed in the wall of the base 140 so as to act on a spring blade of the corresponding terminal, which spring blade is adapted to flatten the stripped end of the electrical conductor against the cage of the connection terminal. Each disconnection lever includes a user-accessible control lever 155 on the outside of said base (FIGS. 1 and 2). The connection means are not the subject of the present invention, and they are not described in greater detail herein.

In conventional manner, the switch mechanism housed inside the base 140 includes a brush that is adapted to rock about a rocking axis between two extreme positions, so as to make or break contact between a movable contact element, e.g. a movable contact stud, and at least one stationary contact element, e.g. a stationary contact stud.

By way of example, the movable contact stud may be carried by the brush, and the stationary contact studs may be carried by contact blades that are electrically connected to respective ones of the electrical-connection terminals.

The switch mechanism also includes drive means for causing the brush to rock by actuating the control button 110.

In particular, the drive means comprise the driver 200 that is mounted to move relative to the base 140 (FIGS. 1, 2, and 5 to 9).

The driver 200 is adapted to move between two positions so as to make or break contact between the movable contact element and the stationary contact element. The driver 200 is moved by the user actuating the control button 110; 310; 410.

The driver 200 is mounted to rock relative to the base 140 about a rocking axis that is defined by two pins 217 (FIG. 5).

In a variant, it may be envisaged that the driver is mounted to move in translation on the base.

The control button 110; 210; 310 is mounted in stationary manner on the driver 200 that is mounted to move relative to the base 140, thereby causing the control button 110; 210; 310 to move.

The electrical switch 100 also includes resilient rocking means that, after passing through a hard point, are suitable for urging the brush towards one or the other of its extreme positions when the driver is rocked. The driver 200 thus presents two stable positions, and the movable contact stud remains alternately in contact with one and then the other of the stationary contact studs.

In a variant, the switch mechanism may also include resilient return means that tend to return the driver continuously towards a rest position. The movable contact stud thus establishes transitory electrical contact with one of the stationary contacts when the control button is actuated by the user. It then breaks contact when the control button is released. The switch mechanism is thus referred to as a monostable mechanism.

As shown in FIG. 1, the front-face assembly 170 of the electrical switch 100 of the invention comprises the control button 110, a trim plate 120, and a finishing plate 130.

The control button 110 is attached to the driver 200, whereas the trim plate 120 is mounted on the base 140 of the switch assembly 160, and the finishing plate is mounted on the support 150.

In conventional manner, the trim plate 120 comprises a plate that is provided with a central opening that surrounds the control button 110. Ignoring clearance, its internal peripheral outline 121 corresponds to the external outline of the control button 110. Its external outline is bordered by a drop wall 122 and presents a shape that is circular, in this embodiment.

The trim plate 120 covers a front portion of the base 140.

The finishing plate 130 comprises a plate that is provided with a central opening that surrounds the trim plate 120. Ignoring clearance, its internal peripheral outline 131 corresponds to the external outline of the trim plate 120. Its external outline 132 is bordered by a drop wall and presents a shape that is substantially square, in this embodiment.

It covers the remainder of the base 140 and the front portion of the support 150 left uncovered by the trim plate 120, and it is for extending over a portion of the wall surface on which the electrical switch is fitted, so as to finish off the assembly.

FIG. 1 shows the front-face assembly 170 associated with a first type of control button 110. However, a similar front-face assembly is associated with the control buttons of a second type shown in FIGS. 3 and 4. For control buttons of the second type, the associated trim plate covers not only a front portion of the base, but also a portion of the driver left uncovered by the control button.

The first and second types of control buttons differ only by their shapes and/or their dimensions. They are both accessible to the user only via the front face of the corresponding electrical switch.

As shown more precisely in FIG. 5, in the preferred embodiment shown, the driver 200 includes a top portion 210 with a main wall 211 from which there extends two facing mount walls 212, 213, having inside faces 212A, 213A that face towards each other, and having outside faces 212B, 213B that face away from said inside faces 212A, 213A.

The mount walls 212, 213 form a mount element having outside faces that are the outside faces 212B, 213B of the two mount walls 212, 213.

Said main wall 211 of the top portion 210 of the driver 200 presents an elongate shape that is generally rectangular, as can be seen in FIG. 6.

The main wall 211 includes a front face 211A and a rear face 211B (FIGS. 6 and 9). A longitudinal groove 218 is set back in the front face 211A of the main wall 211.

The mount walls 212, 213 extend from the front face 211A of the main wall 211, substantially perpendicularly to the main wall 211. They extend lengthwise over a central portion of said front face 211A. Their outside faces face away from each other and are parallel.

More precisely, the mount walls 212, 213 border the longitudinal groove 218 formed in the front face 211A of the main wall 211.

The driver 200 also includes an actuator pillar 216 that extends towards the rear, substantially perpendicularly to the rear face 211B of the main wall 211 of the top portion 210 of the driver 200 (see in particular FIGS. 6, 7, and 9).

The actuator pillar 216 co-operates in conventional manner with the resilient rocking means and the brush of the electrical switch mechanism. Such co-operation is not the subject of the present invention, and is not described in greater detail herein.

The driver 200 is preferably made as a single piece made of molded plastics material.

The mount element formed by the mount walls 212, 213 allows a first type of control button 110 to be mounted on the driver 200.

To this end, each mount wall 212, 213 includes, on its outside face 212B, 213B, first catch means 214 for mounting said first type of control button 110 on said driver 200 (FIGS. 2, 5, 6, and 8).

The first catch means are accessible via the outside of the mount element.

The first catch means 214 includes a first catch surface 214A (FIG. 8).

The first catch surface 214A forms part of a snap-fastener tooth 214 that projects from the outside face 212B, 213B of the corresponding mount wall 212, 213.

Four first catch means 214 are provided including four snap-fastener teeth 214, which catch means are arranged at respective ones of the longitudinal ends of the outside faces 212B, 213B of the mount walls 212, 213.

Each first catch means is arranged in the proximity of the front edge of the outside face 212B, 213B of the corresponding mount element 212, 213, i.e. along the free edge of the corresponding mount wall 212, 213.

In a variant, the first catch surface forming the first catch means may form part of a rib that extends along the outside face of the corresponding mount wall, or indeed a housing that is set back in the outside face locally, or even a groove that is set back in the outside face along its entire length.

Whatever the configuration, the first catch surface 214A is accessible from the outside of the driver 200, i.e. on the corresponding outside face 212B, 213B of the mount element formed by the mount walls. It is accessible exclusively on the outside face 212B, 213B.

The first type of control button corresponds to a first embodiment of the control button 110, as shown in FIGS. 1, 2, 10, and 11.

The control button 110 in this first embodiment presents an overall width that is greater than the distance between the outside faces 212B, 213B, such that the control button 110 is adapted to cover the driver 200 entirely, at least in width.

Preferably, in this first embodiment, the control button 110 covers the mount element, formed of two mount walls 212, 213, so as to cover the mount element entirely. The mount element is thus housed, at least in part, in the control button 110.

More precisely, the control button 110 comprises a front wall 111 that is bordered along its entire periphery with a side drop wall 112. The side drop wall 112 extends towards the rear, substantially perpendicularly to said front wall 111.

The front wall 111 presents a shape that is rectangular along a longitudinal axis X1 (FIG. 2).

In this embodiment, it is substantially plane. In a variant, the front wall may be slightly convex towards the front, or slightly depressed.

Whatever the shape of the control button 110, the front face 111A of its front wall 111 is accessible to the user for actuating the electrical switch 100.

Two partitions 113, 114 extend from a rear face 111B of the front wall 111 (FIG. 10), in such a manner as to be framed by the side drop wall 112. The two partitions 113, 114 extend facing each other, parallel to the longitudinal axis X1 of the front wall 111.

Each of them comprises an inside face 113A, 114A and an opposite outside face 113B, 114B. The inside faces 113A, 114A of the two partitions 113, 114 face towards each other. Ignoring clearance, their spacing is equal to the spacing between the outside faces 212B, 213B of the mount walls 212, 213 of the driver 200.

The control button 110 is provided with complementary first catch means 115 that are adapted to co-operate, in retention, with said first catch means 214 of the driver 200.

In this embodiment, on its inside face 113A, 114A, each partition 113, 114 of the control button includes two housings 115 (FIGS. 10 and 11), each adapted to receive one of the snap-fastener teeth 214 of the driver 200. Each of the housings 115 of the control button 110 includes a complementary first catch surface 116 that is adapted to co-operate, in retention, with the first catch surface 214A of the corresponding snap-fastener tooth 214, so as to hold the first type of control button 110 on the driver 200.

Remarkably, said mount element of the driver 200, formed by said mount walls 212, 213, includes second catch means 215 that are accessible in an internal region R (FIG. 5) that is situated between said outside faces 212B, 213B, for mounting a second type of control button 310; 410 (FIGS. 3 and 4) on said driver 200.

More precisely, as for the first catch means 214, each second catch means 215 includes a second catch surface 215A (see FIG. 7) that is adapted to co-operate, in retention, with complementary second catch means of said second type of control button 310; 410 for fitting on said driver 200.

In the examples shown, the first and second catch means are distinct, and the first and second catch surfaces are separate. In other words, the first and second catch surfaces are disjoint, in the sense that they extend at a distance from each other.

The first type of control button 110 co-operates exclusively with said first catch means, whereas the second type of control button 310; 410 co-operates exclusively with the second catch means.

Said internal region R comprises an internal portion 220 of the driver 200, which internal portion is defined by the inside faces 212A, 213A of the mount walls 212, 213, and by the front face 211A of the main wall 211 of the top portion 210 of the driver 200.

In the example shown in the figures, each second catch surface 215A forms part of a housing 215 that is set back in the inside face 212A, 213A of one of the mount walls 212, 213.

As shown in FIG. 7, the housing 215 is set back in the corresponding mount wall 212, 213, and opens out via an opening 219 (FIG. 5) onto the inside face 212A, 213A of the corresponding wall, in the internal portion 220 of the driver 200, that forms part of the internal region R.

The opening 219 of the housing 215 extends in the proximity of the front face of the main wall 211 of the top portion 210 of the driver 200.

It is arranged in the middle of the inside face 212A, 213A of the corresponding mount wall 212, 213.

There are thus two facing housings 215. Each mount wall 212, 213 thus includes a single second catch means arranged in the middle of the corresponding mount wall 212, 213.

Consequently, the second catch surface 215A is accessible from the internal region R of the driver 200. It is accessible only from the internal portion 220 of the driver, situated in the internal region R.

In practice, since the first catch surfaces 214A are accessible via the outside of the mount walls 212, 213, and the second catch surfaces 215A are accessible via the inside of the mount walls 212, 213, said first catch surfaces 214A are spaced apart from each other by an average distance D (FIG. 8) that is greater than the average distance D′ between the second catch surfaces 215A (FIG. 7).

In a variant, it may be envisaged that each second catch surface forms part of a groove that is set back in one of said inside faces of said mount walls, and that opens out into said internal region that extends along the entire inside face of the corresponding mount wall.

It is also possible to envisage that it forms part of a catch tooth or of a rib that projects from one of said inside faces of said mount walls, into the internal region of the driver.

Said second catch means 215 of the driver 200 are adapted to co-operate, in retention, with complementary second catch means of the second type of control button 310; 410 (FIGS. 3 and 4) for fitting on said driver 200.

The second type of control button 310; 410 comprises two embodiments shown in FIGS. 3 and 4 respectively.

The second type of control button 310; 410 includes a front wall 311; 411 that is bordered along its entire periphery by a drop wall 314, 414 that extends towards the rear, substantially perpendicularly to said front wall 311; 411. The front wall 311; 411 presents a shape that is rectangular, and elongate along a longitudinal axis X2; X3.

In these embodiments, it is slightly convex towards the front of the control button 311; 411, as shown in FIGS. 3 and 4.

In a variant, the front wall may be plane or slightly depressed.

At least one portion of the front wall 311; 411 is accessible to the user for actuating the electrical switch 100. The control button 310; 410 presents a width that makes it suitable for housing, at least in part, between the outside faces 212B, 213B of the mount element of the driver 200.

More precisely, the width of the control button 310; 410 is such that most of said control button is housed between the mount walls 212, 213 of the driver 200. This width is much smaller than the width of the control button 110 of the first embodiment.

The drop wall 314; 414 includes two longitudinal walls portions 312, 313; 412, 413 that border the front wall 311; 411 longitudinally, along the longitudinal axis X2; X3 of the front wall 311; 411. Each of the longitudinal walls portions 312, 313; 412, 413 comprises an outside face 312A, 313A; 412A, 413A that faces outwards from the control button 310; 410, and an inside face 312B, 313B that faces inwards from the control button (see FIGS. 3 and 12 to 16, not shown in FIG. 4).

Each longitudinal wall portion 312, 313; 412, 413 is provided with complementary second catch means 315; 415 that are adapted to co-operate, in retention, with said second catch means 215 of the driver 200 (FIGS. 3, 4, and 12 to 16).

More precisely, each longitudinal wall portion 312, 313; 412, 413 of the control button 310; 410 includes two slots 317 that cut out, in this portion, a snap-fastener tab 316; 416 that is provided at its free end with a snap-fastener tooth 315 that faces outwards from the control button 310; 410. Thus, each snap-fastener tooth 315; 415 projects from the outside face 312A, 313A; 412A, 413A of each longitudinal wall portion 312, 313; 412, 413 of the control button 310; 410 (FIGS. 3, 4, and 12 to 16).

Each snap-fastener tooth 315; 415 of the control button 310; 410 includes a complementary catch face 315A; 415A that faces towards the front of the control button 310; 410, and that is adapted to co-operate, in retention, with the second catch face 215A of the housing 215, forming the second catch means of the driver 200 (FIGS. 3, 4, and 16).

The two embodiments of the second type of the second control button 310; 410 differ only by the fact that one of them includes a front wall 311 that is smooth (FIGS. 3 and 12 to 16), whereas the other includes a front wall 411 that includes a control lever 418 that projects towards the front (FIG. 4).

In the second embodiment shown in FIG. 3 and in FIGS. 12 to 16, the control button 310 thus includes two actuation zones that are accessible at each of the ends of a front face 311A of the front wall 311 of the button, so as to enable the user to actuate it.

In the third embodiment shown in FIG. 4, the control button 410 includes the actuation lever 418 that projects from a central portion of a front face 411A of the front wall 411 of the control button, and that is accessible to the user for actuating the electrical switch 100.

Whatever the embodiment of the control button 110; 210; 310, it is adapted to act on the top portion 210 of the driver 200 of the switch mechanism when it is actuated by the user.

Each control button 110; 310; 410 may be made as a single piece by molding a plastics material, e.g. acrylonitrile butadiene styrene (ABS) or polycarbonate. In a variant, it may be made of wood or of porcelain.

In the two embodiments of the second type of control button 310; 410, bumps 319; 419 that project from the edge of the longitudinal wall portions 312, 313; 412, 413 constitute centering elements for centering the control button on the driver 200 (FIGS. 3, 4, 12).

By means of the driver 200 of the invention, it is possible to manufacture various types of electrical switch 100 including various types of control button associated with the driver 200.

More precisely, the user may alternatively mount the control button 110 of the first type or one of the control buttons 310; 410 of the above-described second type.

In order to mount the first type of control button 110 on the driver 200, the user fits the control button 110 on the mount walls 212, 213 of the driver 200.

The user then presses on the front face 111A of the front wall 111. The partitions 113, 114 elastically deform in such a manner as to move apart, so as to allow the mount walls 212, 213 of the driver 200 to pass between the partitions 113, 114.

When the partitions 113, 114 are pressed sufficiently against the mount walls of the driver 200 for the snap-fastener teeth 214 of the mount walls 212, 213 to reach the housings 115 of the partitions 113, 114 of the control button 110, the partitions 113, 114 return to their initial shape, and each housing 115 comes to surround a snap-fastener tooth 214 of the driver.

The control button 110 is thus clipped on the driver 200. Each snap-fastener tooth 214 projecting from the outside face 212B; 213B of each mount wall 212; 213 of the driver 200 is thus housed in the housing 115 set back in the inside face 113A, 114A of each partition 113, 114 of the first control button 110.

To make clipping easier, each snap-fastener tooth 214 includes a sloping panel that makes it easier for the partitions 113, 114 of the control button to deform elastically, and that makes it easier for the snap-fastener tooth 214 of the driver to pass towards the housing 115 of the corresponding partition.

After snap-fastening each snap-fastener tooth 214 of the driver 200 in the corresponding housing 115 of the control button 110, when the control button 110 is pulled towards the front, the catch face 214A of the snap-fastener tooth 214, that is directed towards the rear of the driver 200, comes into abutment against the complementary catch face 115A of the housing 115 of the control button 110, that faces towards the front of the driver 200.

The control button 110 is thus held on the driver 200.

Advantageously, the control button 110 catches on the outside face 212B, 213B of the mount walls of the driver 200.

Specifically, the first catch means 214 of the driver 200 are accessible on the outside face 212B, 213B of the mount element of the driver.

Consequently, the internal region R of the driver 200, covered by the front wall 111 of the control button 110, forms a closed empty housing that may advantageously receive an indicator lamp. The indicator lamp (not shown) is in the form of a printed circuit including a light-emitting diode and a thickness of plastics material overmolded on the diode. Two connection pins pass through the printed circuit and are guided through two orifices 270 of the main wall 211 of the top portion 210 of the driver 200, for electrically connecting to the connection means housed in the base 140 (FIGS. 6 and 9).

In order to mount the second type of control button 310; 410 on the driver 200, the user fits the control button 310; 410 on the mount walls 212, 213 of the driver 200.

The user then presses on the front face 311A; 411A of the front wall 311; 411. The snap-fastener tabs 316; 416 of the longitudinal wall portions 312, 313; 412, 413 elastically deform towards the inside of the control button 310; 410 so as allow the longitudinal wall portions 312, 313; 412, 413 of the control button 310; 410 to pass between the mount walls 212, 213 of the driver 200.

When the longitudinal wall portions 312, 313; 412, 413 of the control button 310; 410 are pressed in sufficiently against the mount walls of the driver 200 so that the snap-fastener teeth 315; 415 of the snap-fastener tabs 316; 416 of the control button 310; 410 reach the opening 219 of the housings 215 of the driver 200, the snap-fastener tabs 316; 416 return to their initial shape, and the snap-fastener tooth 315; 415 of each snap-fastener tab 316; 416 becomes inserted in the housing 215 of the corresponding driver.

To make insertion easier, each snap-fastener tooth 315; 415 includes a sloping panel that makes it easier for the snap-fastener tooth to pass towards the corresponding housing.

Thus, each snap-fastener tooth 315; 415 projecting from the outside face 312A, 313A; 412A, 413A of each longitudinal wall portion 312, 313; 412, 413 of the control button is housed in the corresponding housing 215 set back in the inside face 212A, 213A of each mount wall 212, 213 of the driver 200. The control button 310; 410 is thus clipped on the driver 200.

After snap-fastening each snap-fastener tooth 315; 415 of the control button 310; 410 in the housing 215 of the driver 200, when the control button 310; 410 is pulled towards the front, the complementary catch face 315A; 415A of the snap-fastener tooth 315; 415, that is directed towards the front of the driver 200, comes into abutment against the catch face 215A of the housing 215 of the driver 200, that faces towards the rear of the driver 200.

The control button 310; 410 is thus held on the driver 200.

Advantageously, the second control button catches from the internal region R of the mount walls of the driver 200. In this configuration, the inner portion 220 of the driver 200 receives a portion of the second control button 310; 410. The control button may thus present a width that is very small.

The driver 200 may thus receive a first type of control button, possibly with an indicator lamp for backlighting the button, and a second type of control button that is much narrower, making it possible to have a very different finish to the electrical switch without imposing the use of a dedicated driver.

A driver is described above having a mount element that is formed by two mount walls, the second catch means being accessible through an opening of the inside face of one of the mount walls, or being formed projecting from the inside face.

In a variant, the second catch means, accessible via the internal region of the driver, may be formed projecting from the main wall of the top portion of the driver. They may be snap-fastener teeth carried by pegs projecting from the main wall. They may equally be housings that open out onto an opening that is formed in the front face of the main wall, and that is accessible through the main wall.

In a variant, it may be envisaged that the mount element is formed as a single block that projects from the front face of the main wall of the driver, substantially perpendicularly to said driver. In this configuration, two opposite side faces of the block that project from the front face of the main wall of the driver constitute the outside faces of the mount element. They may include first catch means similar to the first catch means described above.

In this configuration, and by way of example, the second catch means may include a housing set back in the block, and defining one or more catch surfaces that are adapted to co-operate with one or more catch teeth of a control button. By way of example, each catch tooth of the control button thus extends from a mount projecting from the front wall of the button, towards the rear.

1. A driver (200) for an electrical switch (100), which driver is adapted to move between two positions so as to make or break contact between a movable contact element and a stationary contact element, and which driver includes a top portion (210) that includes a mount element with two outside faces (212B, 213B) that face away from each other, each provided with first catch means (214) for mounting a first type of control button (110) on the driver (200), wherein said mount element includes second catch means (215) that are distinct from said first catch means (214), and that are accessible in an internal region (R) that is situated between said outside faces (212B, 213B), for mounting a second type of control button (310; 410) on said driver (200).

2. A driver (200) according to claim 1, wherein each first catch means (214) includes a first catch surface (214A) that is adapted to co-operate, in retention, with a complementary first catch means (115) of said first type of control button (110).

3. A driver (200) according to claim 2, wherein each first catch surface (214A) forms part of a catch tooth (214) or of a rib that projects from one of said outside faces (212B, 213B) of the mount element.

4. A driver according to claim 2, wherein each first catch surface forms part of a housing or of a groove that is set back in one of said outside faces of the mount element.

5. A driver (200) according to claim 1, wherein four first catch means (214) are provided, each arranged at a respective one of the ends of said outside faces (212B, 213B) of the mount element of said driver (200).

6. A driver (200) according to claim 1, wherein each first catch means (214) is arranged in the proximity of the front edge of the outside face (212B, 213B) of the corresponding mount element.

7. A driver (200) according to claim 1, wherein said mount element includes two mount walls (212, 213) that are arranged facing each other, each of the mount walls (212, 213) including an inside face (212A, 213A) that faces the other mount wall (212, 213) and that faces away from one of said outside faces (212B, 213B) of the mount element, said inside faces (212A, 213A) of the mount walls (212,213) co-operating with a main wall (211) of the driver (200) to define a portion (220) of said internal region (R).

8. A driver (200) according to claim 1, wherein each second catch means (215) includes a second catch surface (215A) that is adapted to co-operate, in retention, with complementary second catch means (315; 415) of said second type of control button (310; 410).

9. A driver according to claim 8, wherein each second catch surface forms part of a catch tooth or of a rib that projects from one of said inside faces of said mount walls, into the internal region.

10. A driver according to claim 8, wherein each second catch surface (215A) forms part of a housing (215) or of a groove that is set back in one of said inside faces (212A, 213A) of said mount walls (212, 213), and that opens out into said internal region.

11. A driver (200) according to claim 10, wherein each of said housings (215) or grooves opens out into an opening (219) of the inside face (212A, 213A) of the corresponding mount wall (212, 213), in the proximity of said main wall (211) of the driver (200).

12. A driver (200) according to claim 7, wherein second catch means (215) are provided in each mount wall (212, 213), which second catch means are arranged in the middle of the inside face of the mount wall.

13. An electrical switch (100) comprising a base (140) housing an electrical switch mechanism with a movable electrical contact element, a stationary electrical contact element, and a driver (200) according to claim 1, the driver (200) being adapted to move between two positions so as to make or break contact between said movable contact element and said stationary contact element.

14. An electrical switch (100) according to claim 13, further comprising a first type of control button (110) having a width that makes it suitable for housing said mount element of the driver (200), and including a front wall (111) from which two partitions (113, 114) extend, each provided with complementary first catch means (115) that are adapted to co-operate, in retention, with said first catch means (214) of the driver (200).

15. An electrical switch according to claim 13, further comprising a second type of control button (310; 410) having a width that makes it suitable for being housed, at least in part, between the outside faces (212B, 213B) of the mount element of the driver (200), and including a front wall (311; 411) from which two drop walls (312, 313; 412, 413) extend, each provided with complementary second catch means (315; 415) that are adapted to co-operate, in retention, with said second catch means (215) of the driver (200).
